(19) United States
(12) Patent Application Publication
(10) Pub. No.: US 2008/0014918 A1
(43) Pub. Date: Jan. 17, 2008

(54) Communication quality measuring device, communication quality measuring method and communication measuring program in computer-readable medium

(75) Inventors: Tetsuya Ito, Tokyo (JP); Akira Matsumoto, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: NEC COMMUNICATION SYSTEMS, LTD, Tokyo (JP); NEC INFRONTIA CORPORATION, Kawasaki-shi (JP)

(21) Appl. No.: 11/822,743

(22) Filed: Jul. 9, 2007

(30) Foreign Application Priority Data
Jul. 10, 2006 (JP) 189828/2006

(51) Int. Cl. H04B 17/00

(52) U.S. Cl. 455/423

(57) ABSTRACT

A communication quality measuring device measures communication quality for recognizing a communication state for a predetermined period. Then, the communication quality measuring device calculates a correlation period during which cases of communication quality measuring unit at a measured particular time. Then, the communication quality measuring device determines a communication quality result at the particular time based on correlation communication quality that is measured during the correlation period.

This application is based upon and claims the benefit of priority from Japanese patent application No. 2006-189828, filed on Jul. 10, 2006, the disclosure of which is incorporated herein in its entirety by reference.

### BACKGROUND OF THE INVENTION

The present invention pertains to a communication quality measuring device, a communication quality measuring method and a communication quality measuring program in a computer-readable medium for measuring communication quality to recognize a communication state, and more specifically for enabling highly accurate measurement of communication quality.

### DESCRIPTION OF RELATED ART

Recently, Wireless LAN (Local Area Network) systems represented as IEEE (Institute of Electrical and Electronics Engineers) 802.11x (x is a generic name of a, b, g and the like) have been widely used.

The wireless LAN system includes a wireless terminal device (STA′) and a plurality of wireless base stations (AP′) for providing wireless communication between the wireless base station (AP′) and the wireless terminal device (STA′) that is present within the coverage of the wireless base station (AP′) as shown in FIG. 1.

The wireless terminal device (STA′) and the wireless base station (AP′) included in the abovementioned wireless communication system measure communication quality, including the received signal strength indicator (RSSI), the frame error rate and the like, determine whether interference occurs or not based on the measurement, and perform control for changing wireless channels or transmission methods.

For example, Japanese Patent Laid Open Publication No. 2004-26063: Patent Document 1 discloses a communication system, in which a user terminal for performing wireless communication connects with a wired network via an access point.

In the Patent Document 1, a user terminal first measures received powers of signals transmitted by a plurality of access points, Then, a desired signal to interference power ratio is determined using a ratio of a signal received power at the access point to which the user terminal belongs, to signal received power at the other access points. If the signal to interference power ratio is larger than a predetermined signal to interference power ratio, then the user terminal is determined to be in the uninterfered region. Otherwise, it is determined to be in an interfered region.

Next, a transmission time from an access point to a user terminal in the uninterfered region and a transmission time from an access point to a user terminal in the interfered region are time-divided to obtain a first time zone and a second time zone, respectively. During the first time zone, a plurality of access points simultaneously communicates with a plurality of corresponding user terminals in the uninterfered region.

During the second time zone, the plurality of access points communicates with the user terminals in the interfered region by performing time division.

Accordingly, the technique is able to avoid interference to a data packet.

Recently, IP telephone communication (VoWLAN: Voice Over Wireless Local Area Network) using the wireless LAN has become popular. The wireless terminals used in the IP telephone communication have been downsized so that an operator can perform the IP telephone communication by applying the wireless terminal to his/her ear during a call or by moving during a call.

The wireless LAN in 2.4 GHz band, however, has a wavelength of 12.5 cm and outstanding proportion of noises would be caused by multipath, movement of the operator during a call or the like, thereby affecting the received signal.

Therefore, as disclosed in Patent Document 1, in a system determining whether interference is occurring or not by obtaining the desired signal to interference power ratio from a ratio of the signal received powers, the abovementioned noise caused by multipath, movement of the operator or the like degrades the accuracy of the received power measured at the user terminal. That may affect the correct determination on whether it is in the uninterfered region or in the interfered region.

The wireless terminal used in the IP telephone communication performs a handover for continuing the wireless communication by switching wireless base stations with which the wireless terminal associated depending on the movement of the operator.

A general handover method is known in which a received signal strength indicator (RSSI) is measured as communication quality for recognizing the communication state and associating the wireless terminal with the wireless base station having the strong received signal strength indicator based on the measured received signal strength indicator.

In the abovementioned handover method, however, various noises may occur due to the environment in which the wireless communication is performed including a noise due to multipath, movement of the operator or the like, a noise due to roaming of the operator, a shielding material intervention and the like. Therefore, the correct measurement of the received signal strength indicator according to the environment in which the wireless communication is performed is impossible. That causes a problem in that audio is disconnected during a call as handover is repeated during the call.

That also causes a problem in that a handover does not take place even when the communication state is degraded.

Thus, a method is needed for highly accurate measurement of the communication quality while taking account of various noises according to the environment in which the wireless communication is performed.

Japanese Patent Laid Open Publication No. 2003-009229: Patent Document 2 discloses a method for searching an unused channel which can be used in the wireless communication system using a plurality of communication channels when cyclical interference having two cycles of a cycle T1 and a cyclc T3 (t1<T3) occurs.

In the Patent Document 2, when the cyclical interference having the two cycles of the cycle Ti and the cycle T3 (t1<T3) occurs, an observation section length T2 that falls between the cycle T1 or more and the cycle T3 or less is set first in the wireless communication system using a plurality of communication channels.

Then, in the plurality of communication channels, observation of interference wares appearing due to occurrence of the cyclic interference is repeated N times (N is an integer of 2 or more) during a period of the cycle T3 using the observation section length T2 as a unit.

Then, an unused channel under little effect of interference is determined based on a state of interference on the plurality of communication channels that can be obtained from the observation results performed N times.

Accordingly, a wireless channel under the smallest effect of interference is selected by taking consideration of periodicity of the interference wave and the characteristics of burst.

The system disclosed in Patent Document 2 observes the interference wave with the fixed unit of the observation section length T2, however, without taking account of changing the observation section length T2 according to the observed interference wave.

Therefore, some of the observation results obtained by using the observation section length T2 as a unit may include an interference wave with large variation. The observation section length T2 with which an interference wave has been observed with large variation could not provide a highly accurate observation result.

If observation is repeated N times using the observation section length T2 when the non-cyclic noise occurs, then the wireless channel having the smallest effect of interference wave may not be selected.

There is a document disclosing a technique of a scanning system of active scanning and passive scanning (for example, see Non-Patent Document 1: ISO/IEC 8802-11 (EEE Std 802.II Second edition 2005-08-01 ISO/IEC 8802 11:2005(E) IEEE Std 802.11i-2003 Edition, Information technology-Telecommunications and information exchange between systems-Local and metropolitan area networks-Specific requirements Part 11: Wireless LAN Medium Access Control (MAC) and Physical Layer (PHY) specifications (Includes IEEE Std 802.11, 1999 Edition; IEEE Std 802.11a-1999; IEEE Std 802.11b.-1999; IEEE Std. 802.11b.-1999/Cor 1-2001; and IEEE Std 802.11d.-2001)).

### SUMMARY OF THE INVENTION

An exemplary feature of the invention is to provide a communication quality measuring device, a communication quality measuring method and a communication quality measuring program for providing highly accurate communication quality measurement by taking account of various noises that occur according to the environment in which the wireless communication is performed.

A communication quality measuring device according to an exemplary aspect of the present invention includes:

a communication quality measuring unit that measures communication quality for recognizing a communication state for a predetermined period;

a correlation period calculating unit that calculates a correlation period during which a correlation is found in the communication quality at a particular time of the predetermined period during which the communication quality measuring section performs measuring; and

a communication quality result determining unit that determines a communication quality result at the particular time based on correlation communication quality that is measured during the correlation period by the communication quality measuring unit.

A communication quality measuring method according to an exemplary aspect of the present invention is for a communication quality device for measuring communication quality for recognizing communication quality, the method includes:

a communication quality measuring step of measuring communication quality for recognizing a communication state for a predetermined period;

a correlation period calculating step of calculating a correlation period during which a correlation is found in the communication quality at a particular time of the predetermined period during which the communication quality measuring step performs measuring; and

a communication quality result determining step of determining a communication quality result at the particular time based on correlation communication quality that is measured during the correlation period by the communication quality measuring step.

A communication quality measuring program in a computer-readable medium according to an exemplary aspect of the present invention is for a communication quality measuring device for measuring communication quality for recognizing communication quality, the program causing a computer to perform:

a communication quality measuring process for measuring communication quality for recognizing a communication state for a predetermined period;

a correlation period calculating process of calculating a correlation period during which a correlation is found in the communication quality at a particular time of the predetermined period during which the communication quality measuring process performs measuring; and

a communication quality result determining process of determining a communication quality result at the particular time based on correlation communication quality that is measured during the correlation period by the communication quality measuring process.

### BRIEF DESCRIPTION OF THE DRAWINGS

The advantages and features of the present invention will become more apparent from the consideration of the following detailed description taken in conjunction with the accompanying drawings, in which:

FIG. 1 is a diagram showing a system configuration of a wireless communication system;

FIG. 2 is a diagram showing a system configuration of a wireless communication system according to the invention;

FIG. 3 is a diagram showing an inner configuration of a wireless base station (AP) forming the wireless communication system according to the invention;

FIG. 4 is a diagram showing an inner configuration of a wireless terminal device (STA) forming the wireless communication system according to the invention;

FIG. 5 is a flowchart showing a communication quality measuring method performed by the wireless base station (AP) and the wireless terminal device (STA) and the like that form the wireless communication system according to the invention;

FIG. 6 is a first diagram for illustrating a communication quality measuring method performed by the wireless base station (AP) and the wireless terminal device (STA) and the like that form the wireless communication system according to the invention;

FIG. 7 is a first diagram for illustrating a communication quality measuring method performed by the wireless base station (AP) and the wireless terminal device (STA) and the like that form the wireless communication system according to the invention;

FIG. 8 is a graph showing a measured result of a received signal strength indicator (RSSI) of a signal that is received by a wireless terminal device (STA) from two different wireless base stations (AP1, AP2) according to the invention;

FIGS. 9A-9C are graphs showing a relationship between a normalizing autocorrelation function: G1(k) and a correlation period: tx at each time of “time A”, “time B” and “time C” shown in FIG. 8, in which 9(a) is a graph corresponding “time A”, 9(b) is a graph corresponding “time B” and 9(c) is a graph corresponding “time C“;

FIG. 10 is a graph showing a measured result in which the average received signal strength indicator: A is calculated at each time of “time A”, “time B” and “time C” shown in FIG. 8;

FIG. 11 is a sequence chart for illustrating a first method for controlling a handover according to the invention;

FIG. 12 is a sequence chart for illustrating a second method for controlling a handover according to the invention;

FIG. 13 is a diagram for illustrating a case in which when a correlation period: txc at the time C is calculated, a median value alpha of the received signal strength indicator measured in the correlation period: txc is calculated, and the calculated median value: alpha is made a value of the received signal strength indicator at the time C;

FIG. 14 is a diagram for illustrating a process in the wireless communication system according to the invention; and

FIG. 15 is a diagram showing a state in which, based on the correlation periods: tx calculated by a predetermined period: N, a “light noise occurrence period”, which is a period of noises with a light effect on the received signal strength: f(t) (correlation period: a period with long tx) occurs, and an “excessive noise occurrence period”, which is a period of noises with an excessive effect on the received signal strength: f(t) occurs (correlation period: a period with short tx) are separated.

### DESCRIPTION OF EXEMPLARY EMBODIMENTS

First, a wireless terminal device (STA), a wireless base station (AP) that form a wireless communication system will be outlined.

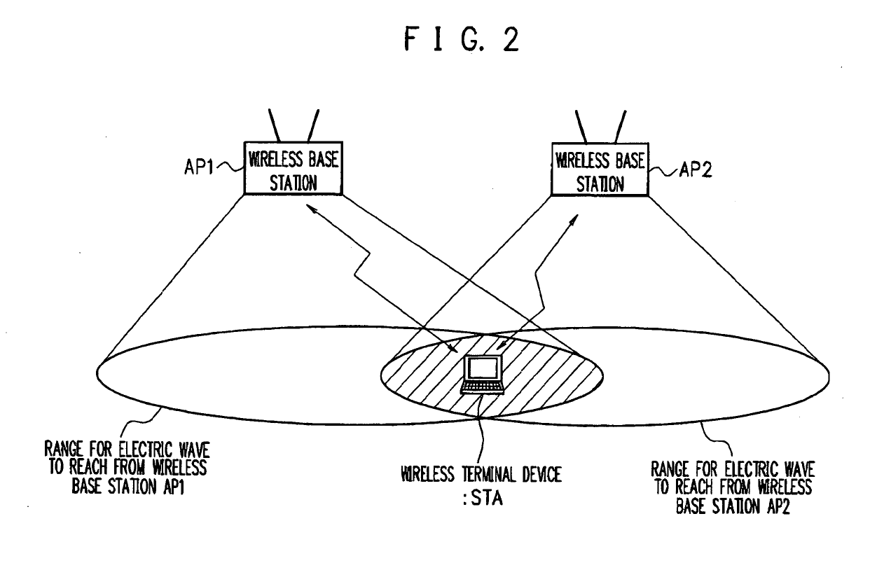

The wireless communication system has a wireless terminal device (STA) and a plurality of wireless base stations (AP) as shown in FIG. 2.

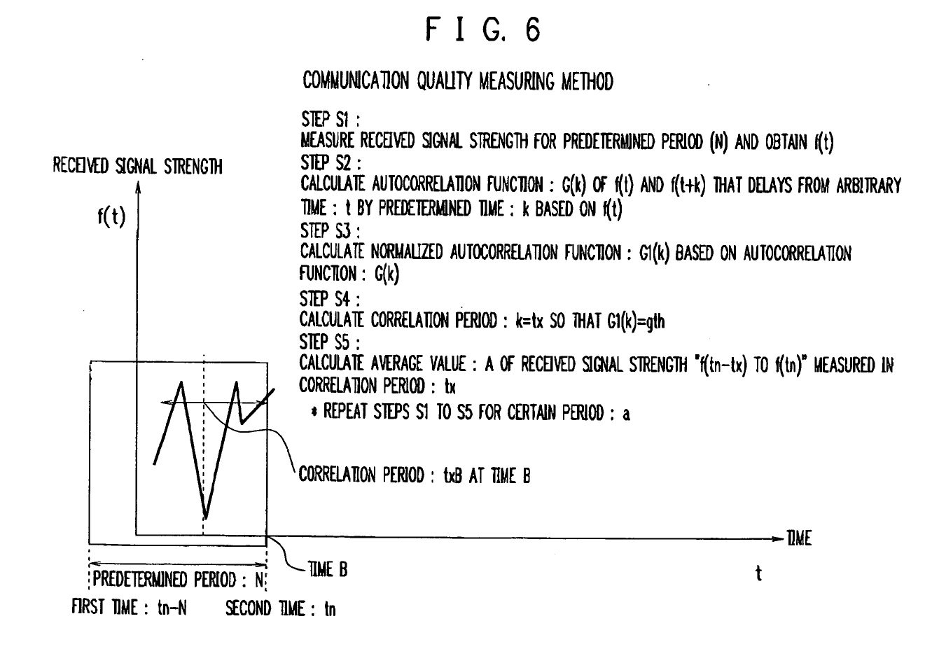

The wireless terminal device (STA) and the wireless base stations (AP) that form the wireless communication system first measure communication quality “f(t)” for recognizing a communication state for a predetermined period “N” as shown in FIG. 6 (step S1).

A correlation period “tx” during which a correlation can be found in the communication quality “f(tn), f(tn−1), f(tn−2), . . . f(tn−tx)” at a particular time “for example, the second time: tn” of the communication quality “f(t)” that is measured for the predetermined period “N”, is calculated (steps S2 to 4).

Based on the correlation communication quality “f(tn−tx) to f(tn)” measured in the correlation period “tx”, the communication quality result at the particular time “tn” is determined (step S5).

Accordingly, the wireless terminal device (STA) and the wireless base stations (AP) change the correlation period “tx” for determining the communication quality result at the particular time “for example, the second time: tn” according to the communication quality “f(t)” that is measured for recognizing a communication state for a predetermined period “N”, and determine the communication quality result at the particular time “tn” based on the correlation communication quality “f(tn−tx) to f(tn)” that is measured in the changed correlation period “tx”.

Thus, the wireless terminal device (STA) and the wireless base stations (AP) can perform highly accurate measuring of communication quality by taking account of various noises occurring according to the environment in which the wireless communication is performed. The wireless communication system in the embodiment will be described in detail below with reference to the attached drawings.

### First Exemplary Embodiment

<System Configuration of the Wireless Communication System>

First, the system configuration of the wireless communication system will be described with reference to FIG. 2.

The wireless LAN system has a wireless terminal device (STA) and a plurality of wireless base stations (AP) as shown in FIG. 2.

It is assumed that the wireless terminal device (STA) forming the wireless communication system is placed within the coverage of a plurality of wireless base stations (AP1, AP2) and the wireless terminal device (STA) belongs to the wireless base station (AP1).

The wireless base station (AP1), to which the wireless terminal device (STA) belongs, is called the “belonged wireless base station”; and the wireless base station (AP2), to which the wireless terminal device (STA) does not belong, is called a “neighbor wireless base station”.

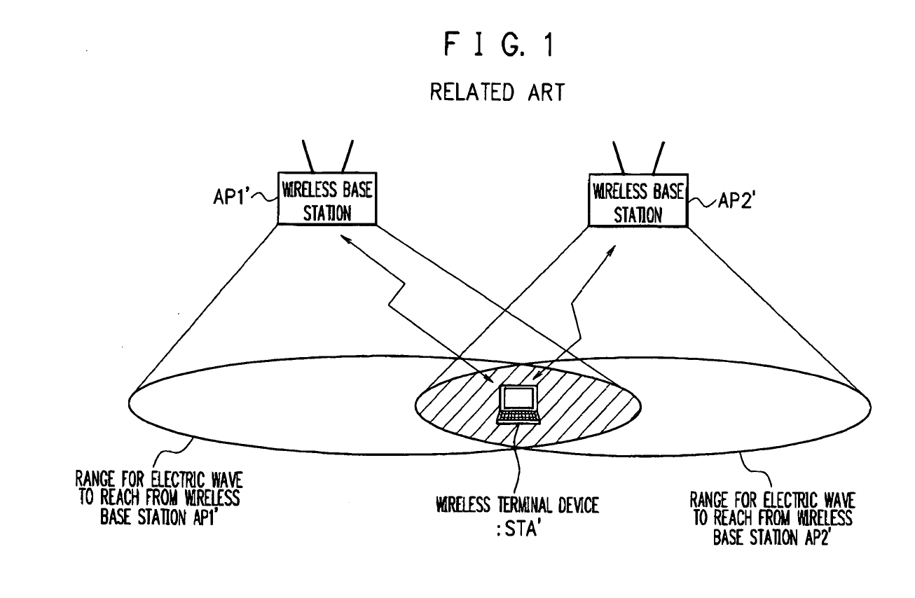

The wireless LAN system is not limited to the system configuration shown in FIG. 1 and can include any number of the wireless terminal devices (STA) and the wireless base stations (AP) without limitation.

<Wireless Base Station: Inner Configuration of AP>

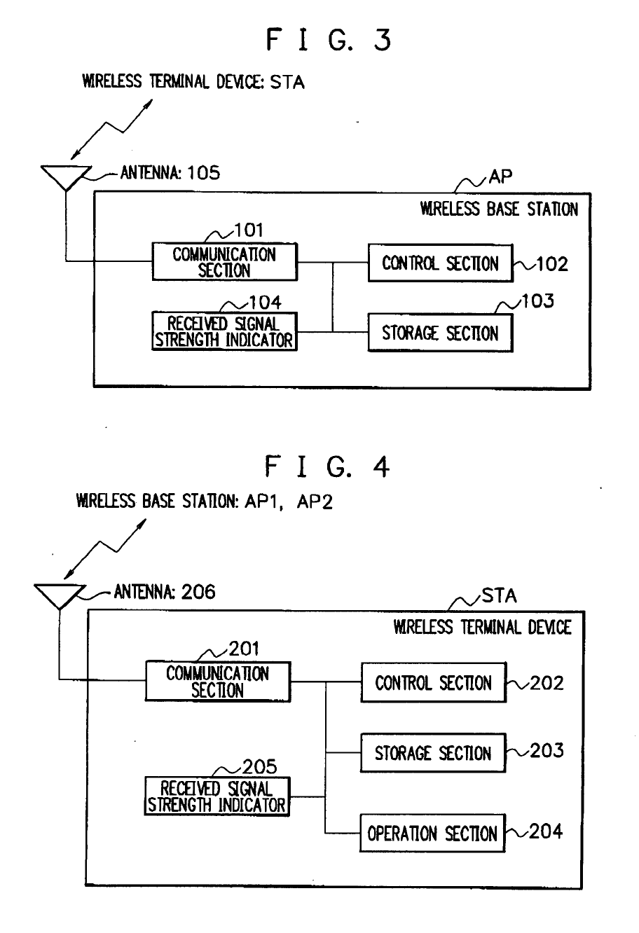

Now, an inner configuration of the wireless base station (AP) of the embodiment will be described with reference to FIG. 3.

The wireless base station (AP) includes a communication unit (101), a control unit (102), a storage unit (103), a received signal strength indicator measuring unit (104) and an antenna (105) as shown in FIG. 3.

The communication unit (101) establishes a wireless channel between itself and the wireless terminal device (STA) via the antenna (105) for exchanging information at an arbitrary frequency. The communication unit (101) exchanges information with another wireless base station.

The control unit (102) collectively controls the wireless base station (AP).

The storage unit (103) stores various setting values for the wireless base station (AP) and temporary accumulating information exchanged via the communication unit (101).

The various setting values stored in the storage unit (103) include a wireless channel and a service set identifier (SSID).

The received signal strength indicator measuring unit (104) measures the received signal strength indicator (RSSI) for the radio signal received by the communication unit (101).

<Wireless Terminal Device: Inner Configuration of STA>

Now, the inner configuration of the wireless terminal device (STA) will be described with reference to FIG. 4.

The wireless terminal device (STA) includes a communication unit (201), a control unit (202), a storage unit (203), an operation unit (204), a received signal strength indicator measuring unit (205) and an antenna (206) as shown in FIG. 4.

The communication unit (201) establishes a wireless channel between itself and the wireless terminal device (AP) via the antenna (206) for exchanging information at an arbitrary frequency.

The control unit (202) collectively controls the wireless base terminal device (STA).

The storage unit (203) stores various setting values for the wireless terminal device (STA) and temporarily accumulating information exchanged via the communication unit (201).

The various setting values include a threshold for the received signal strength indicator (RSSI), which is a criterion of execution for determining whether to perform a handover.

The operation unit (204) inputs information for setting various setting values to be stored in the storage unit (203) or inputs command information for executing various types of control in the wireless terminal device (STA).

The various setting values include a threshold for the received signal strength indicator (RSSI), which is a criterion of execution for determining whether or not to perform a handover.

A received signal strength measuring unit (205) measures the received signal strength indicator (RSSI) of the radio signal which is received by the communicating unit (201).

<Operation>

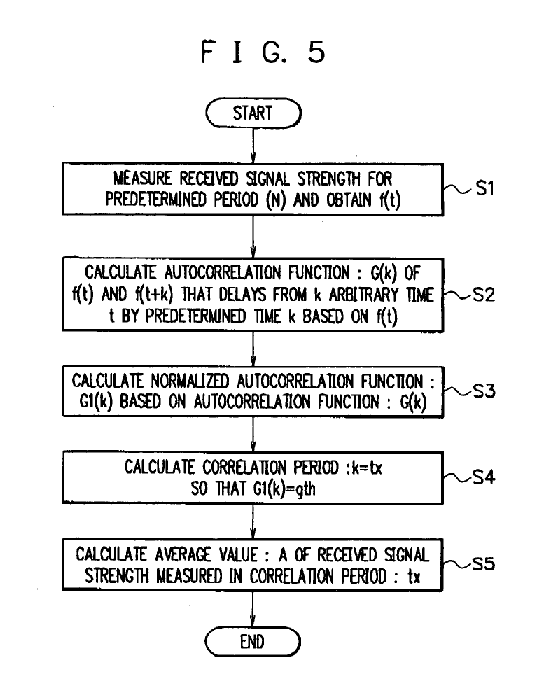

Now, a method for measuring the communication quality performed by the wireless terminal device (STA) and the wireless base stations (AP) that form the wireless communication system of the exemplary embodiment of the invention will be described with reference to FIG. 5 and FIG. 6.

Although it is assumed that the received signal strength is measured as the exemplary communication quality in the description below, the method for measuring the communication quality is not limited to measuring the received signal strength and any information can be measured as the communication quality if only it is the information for recognizing a communication state.

The description below will mention a method for measuring the communication quality performed by the wireless terminal device (STA), the same measuring method being performed in the wireless base station (AP).

The vertical axis in FIG. 6 shows values of the received signal strength indicator (RSSI) and the horizontal axis shows passage of the time: t.

The wireless terminal device (STA) measures the received signal strength (RSSI) of the radio signal received by the communication unit (201) for a predetermined period (N: N is the first time: tn−N to the second time: tn).

Accordingly, the wireless terminal device (STA) obtains the measured result: f(t) of the received signal strength indicator (RSSI) during the predetermined period (N) (step S1).

Next, the wireless terminal device (STA) calculates the autocorrelation function: G(k) with f(t+k) which delays from a certain time: t by a predetermined time: k based on the obtained measured result: f(t) (step S2).

The autocorrelation function: G(k) is calculated using a formula (1) below.

$$G ( k ) = \frac{1}{N} {\sum }_{t = 0}^{N - 1} f ( t ) \times f ( t + k ) \\ k = ( 0 , 1 , 2 , 3 , … N - 1 ) \qquad [ Formula 1 ]$$

Here, N indicates a predetermined period “N” which is measured at the step S1, f(t) indicates the communication quality “f(t)” that is measured for a predetermined period “N”, and (t+k) indicates past communication quality “f(t+k)” that elapses from a certain time: t by a predetermined time; k.

As it is assumed that the wireless terminal device (STA) having a wireless interface calculates a plurality of wireless channels by switching wireless channels, a function is a discrete system that samples the received signal and the autocorrelation function formula of the discrete data as shown in the abovementioned formula (1).

Next, the normalized autocorrelation function: G1(k) is calculated based on the autocorrelation function: G(k) calculated by the abovementioned formula (1) (step S3).

The normalized autocorrelation function: G1(k) is calculated using a formula (2) below.
G₁(k)=G(k)/G(0) [Formula 2]

Here, G(k) indicates the autocorrelation function “G(k)” calculated by the formula (1) at step S2, and G(0) indicates the function “G(0)” that is the autocorrelation function: G(k) calculated by the formula (1) at step S2 substituted with 0.

Next, the correlation period: k=tx, in which a value of the normalized autocorrelation function: G1(k) is a predetermined threshold: gth, is calculated based on the normalized autocorrelation function: G1(k) that is calculated by the formula (2) (step S4).

The correlation period: k=tx, in which a value of the normalized autocorrelation function: G1(k) is a predetermined threshold: gth, is calculated using formula (3) below.
G1(K)=gth [Formula 3]
t=tx

Next, the average of the received signal strength: f(t) that is measured during the correlation period: tx is calculated based on the correlation period: tx that is calculated by formula (3) and an average received signal strength A is calculated (step S5).

The average received signal strength: A is calculated using a formula (4) below.

$$A = \frac{1}{tx} {\sum }_{t = tn - tx}^{tn} f ( t ) \qquad [ Formula 4 ]$$

Here, tx indicates the correlation period “tx”, tn indicates the second time “tn”, and f(t) indicates the communication quality “f(t)” measured for the predetermined period “N”.

By the abovementioned formula (4), the average received signal strength: A of “f(n−tx) to f(tn)” can be calculated. Then, the average received signal strength: “A” calculated using formula (4) is made a value of the received signal strength at the time: t.

The wireless terminal device (STA) performs a series of processes from the abovementioned steps S1 to S5 for every certain period: “a”.

Accordingly, the wireless terminal device (STA) first calculates the correlation period: tx_{B} at the time B, and calculates the average received signal strength: As in the correlation period: tx_{B} at the calculated time B as shown in FIG. 6.

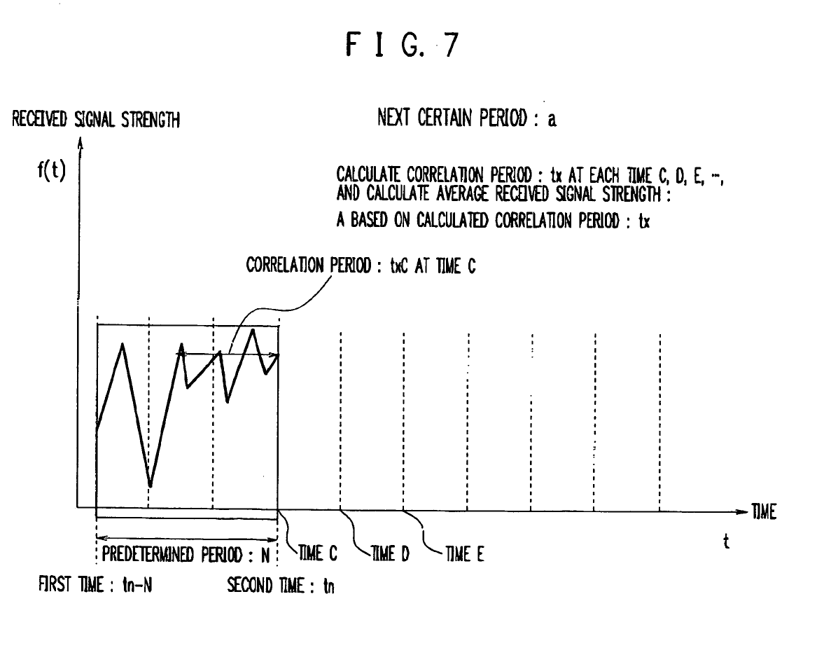

Next, it calculates the correlation period: txc at the time C, and the average received time strength: A_{C} in the correlation period: tx_{C} at the calculated time C as shown in FIG. 7.

That is, the wireless terminal device (STA) performs the abovementioned processing at the times B, C, D, . . . , and for every predetermined period: a.

As such, the wireless terminal device (STA) obtains the measured result of the highly accurate received signal strength by calculating the correlation period: tx (tx_{B}, tx_{C}, tx_{D}, . . . ), during which a correlation is found in the communication quality at each of the times (B, C, D, . . . ) and calculating the average received signal strength; A (A_{S}, A_{C}, A_{D}, . . . ) based on the correlation period at each of the calculated times (B, C, D, . . . ) as shown in FIG. 6 and FIG. 7.

Then, the wireless terminal device (STA) performs interference detecting control and handover control based on the average received signal strength: “A” that is calculated for every certain period: a.

As the noise caused by multipath, movement of the operator or the like has small autocorrelation, the autocorrelation function G(k) of the abovementioned formula (1) absorbs the amount of change in the noise caused by the abovementioned multipath, the movement of the operator or the like. Thus, the amount of change of noise considered and taken into account.

The average value: A of the received signal strength measured within the correlation period; tx calculated by formula (4) has a small amount of change in the received signal strength: f(t) and has continuity in the received signal strength: f(t).

As the amount of change in the received signal strength: f(t) is getting smaller, the correlation period: tx calculated by formula (4) becomes longer. As the amount of change in the received signal strength: f(t) is getting stronger, the correlation period: tx calculated by formula (4) becomes shorter.

Accordingly, if the amount of change in the received signal strength: f(t) is small, then the correlation period: tx becomes long so that the average value: A of the received signal strength measured in almost the same period as a predetermined period (from the first time: tn−N to the second time: tn) is calculated.

If the amount of change in the received signal strength: f(t) is strong, then the correlation period becomes shorter so that the average value: A of the received signal strength measured within a period near the second time: tn in a predetermined period (N: N is from the first time: tn−N to the second time; tn) is calculated. 5 As a result, the measuring period: tx for calculating the average value: A of the received signal strength is changed according to the measured result of the received signal strength: f(t) measured in the predetermined period “N” for recognizing the communication state, and the average value: A of the received signal strength in the correlation period: tx is determined based on the measured result of the received signal strength: f(t) measured during the changed correlation period: tx.

Therefore, the wireless terminal device (STA) obtains a highly accurate measured result in consideration of various noises caused under the environment in which the wireless communication is performed.

<Operations in the Wireless Communication System>

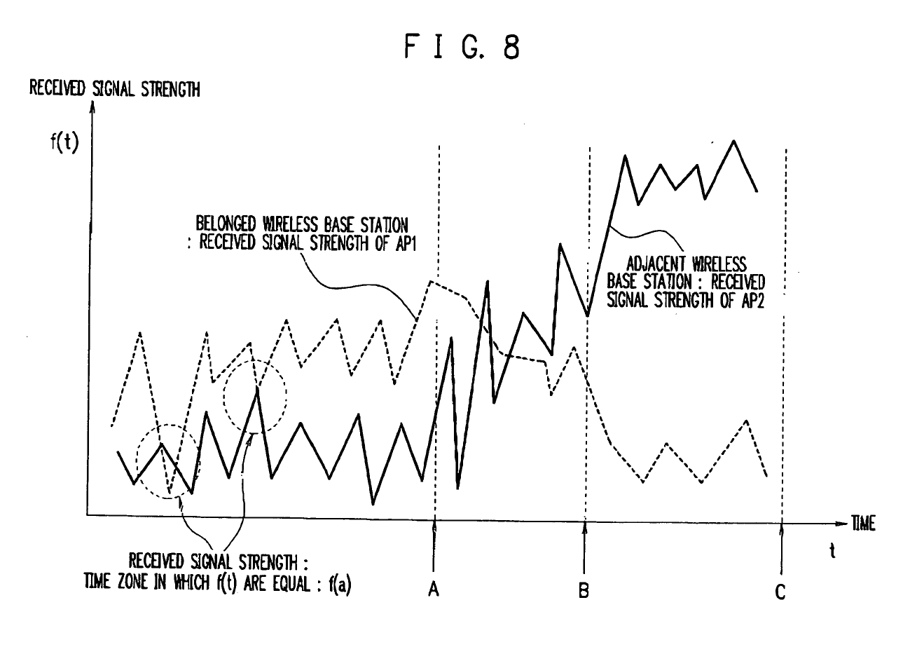

Now, a series of operations in the wireless communication system will be described with reference to FIG. 8 to FIG. 10.

The graph shown in FIG. 8 shows measured results of the received signal strength (RSSI) of signals which the wireless terminal device (STA) shown in FIG. 1 received from two different wireless base stations (AP1, AP2).

The vertical axis shows a value of the received signal strength (RSSI) and the horizontal axis shows the passage of the time: t in FIG. 8.

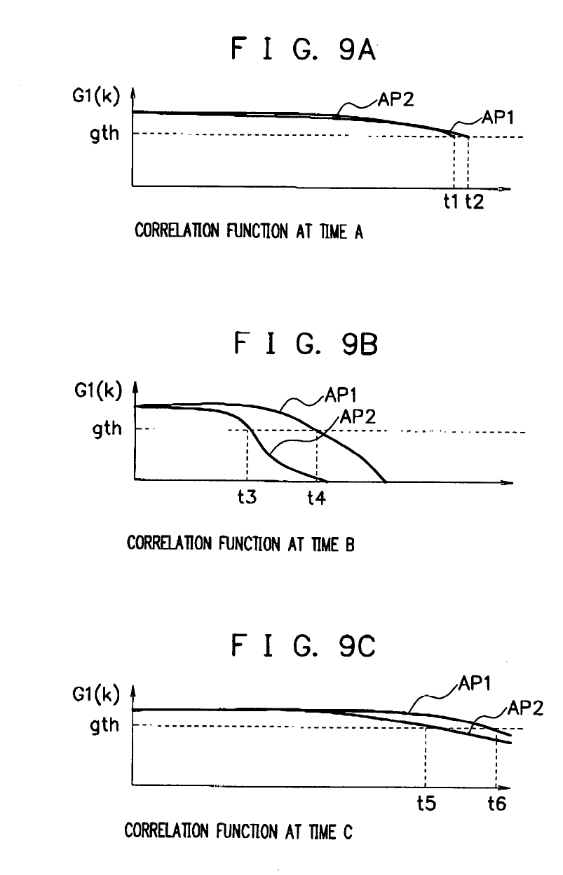

Each of the graphs shown in FIG. 9(a) to (c) shows a relationship between a normalizing autocorrelation function G1(k) and a correlation period: tx at each time of “time A”, “time B” and “time C” shown in FIG. 8 with the vertical axis showing a value of the normalizing autocorrelation function: G1(k) and the horizontal value showing k (=correlation period: tx).

FIG. 9(a) corresponds to the “time A”, FIG. 9(b) corresponds to the “time B” and FIG. 9(c) corresponds to the “time C”.

In FIGS. 9(a)-9(c), each of “t2, t4, t6” shows a correlation period of the received signal strength of the signal received from the belonged wireless base station (AP1) at each of the “time A”, “time B”, and “time C”.

Each of “t1, t3, t5” shows a correlation period of the received signal strength of the signal received from the neighbor wireless base station (AP2) at each of the “time A”, “time B”, and “time C”.

In FIG. 8, the received signal strength: f(t) from the “origin” to the “time A” shows a state time when the wireless terminal device (STA) stops.

The amount of change in the received signal strength: f(t) from the “origin” to the “time A” is the amount of change caused by multipath, movement of the operator or the like, being mainly a noise component. Therefore, the correlation periods (t1, t2) become relatively long as shown in FIG. 9(a).

In FIG. 8, the received signal strength: f(t) from the “time A” to the “time B” shows a state time when the wireless terminal device (STA) moves from the belonged wireless base station (AP1) side to the neighbor wireless base station (AP2) side.

The amount of change in the received signal strength: f(t) from the “time A” to the “time B” shown in FIG. 8 is the amount of change caused by the movement of the wireless terminal device (STA), in which the amplitude of the received signal strength: f(t) has a large change and the correlation period(t3, t4) becomes relatively short as shown in FIG. 9(b).

In FIG. 8, the received signal strength: f(t) from the “time B” to the “time C” shows a state time when the wireless terminal device (STA) stops.

The amount of change in the received signal strength: f(t) from the “time B” to the “time C” is the amount of change caused by multipath, movement of the operator or the like, being mainly the noise component. Therefore, the correlation periods (t5, t6) become relatively long as shown in FIG. 9(c).

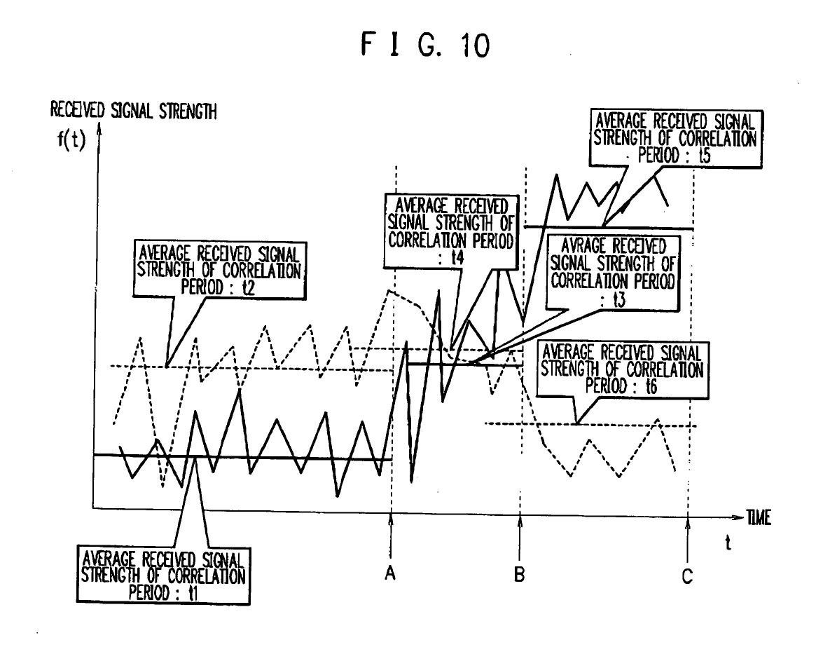

The wireless terminal device (STA) of the embodiment calculates the correlation period: tx at each of the abovementioned “time A”, the “time B”, and the “time C” shown in FIG. 8, and calculates the average received signal strength: A at each of the “time A”, the “time B”, and the “time C” as shown in FIG. 10 based on the calculated correlation period: tx.

Then, the wireless terminal device (STA) performs the interference detecting control and the handover control based on the average received signal strength: A at each time.

Accordingly, the wireless terminal device (STA) performs highly accurate interference detecting control and the handover control.

For example, a desired signal to interference power ratio is obtained by the ratio of a signal received power as disclosed in Patent Document 1. In the system for determining whether interference occurs, the received signal strength: f(t) received by the wireless terminal device (STA) is used as it is as shown in FIG. 8.

As a result, a time zone “f(a) shown in FIG. 8” in which two received signal strengths: f(t) are almost the same occurs in an interval from the “origin” to the “time A”. That leads to an erroneous detection of the time zone as the interference region in the interval from the “origin” to the “time A”.

By performing the interference detecting control based on the average received signal strength: A in the correlation period: tx at each of the abovementioned “time A”, the “time B”, and the “time C” shown in FIG. 10, a time zone in which two received signal strengths: f(t) are almost the same occurs, is eliminated in the interval from the “origin” to the “time A”.

As a result, an erroneous detection of the time zone as the interference region in the interval from the “origin” to the “time A” is avoided. Accordingly, a time zone in which two received signal strengths: f(t) are almost the same occurs in the interval from the “time A” to the “time B”, which enables determination on whether the interval from the “time A” to the “time B” is the interference region or not.

The wireless terminal device (STA) does not perform a handover in the interval from the “origin” to the “time B” if it controls the handover based on the average received signal strength: A of the correlation period: tx at each of the “time A”, the “time B” and the “time C” shown in FIG. 10, and can perform a proper handover after the “time B”.

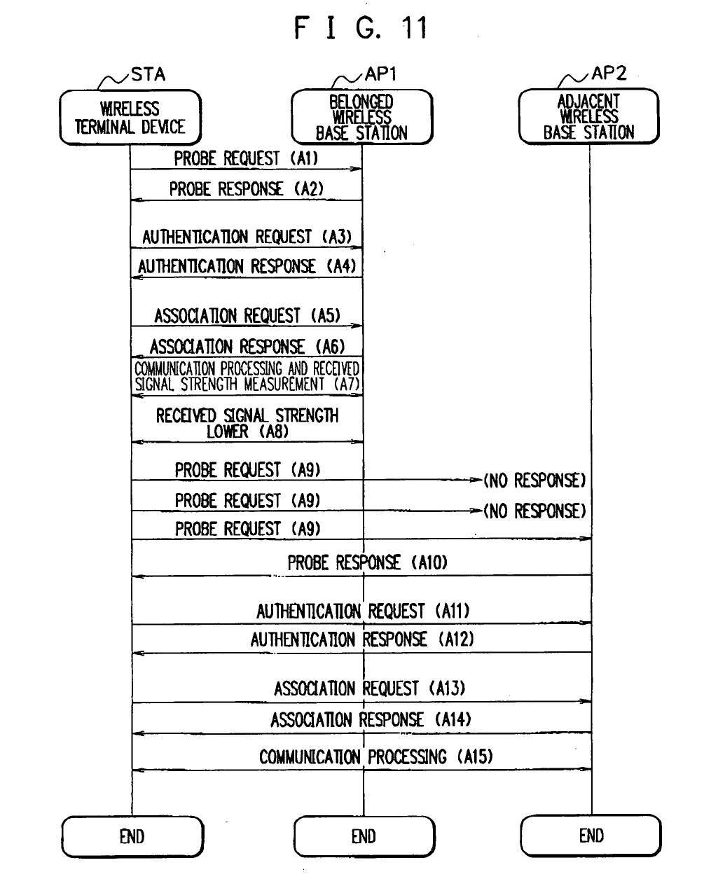

As a method for controlling a handover, a case to which a method shown in FIG. 11 is applied is assumed as an example.

In the method for controlling a handover shown in FIG. 11, the wireless terminal device (STA) first measures the received signal strengths of the wireless terminal device (STA) and the belonged wireless base station (AP1) (A7 of FIG. 11).

Then, the wireless terminal device (STA) compares the measured received signal strength and a threshold, which is an exemplary criterion of executing a handover. When it is determined that the received signal strength of the belonged wireless base station (AP1) goes below the threshold, which is an exemplary criterion of executing a handover, it is determined that the received strength decreases (A8 of FIG. 11). Then, the wireless terminal device (STA) controls to perform a handover to belong to another neighbor wireless base station (AP2) (A9 to A11 in FIG. 11).

In the method for controlling a handover, if the wireless terminal device (STA) controls a handover by using the received signal strength of the belonged wireless base station (AP1) shown in FIG. 8 as it is, erroneous recognition that the received signal strength lowered in the interval from the “origin” to the “time A” occurs, causing a problem in that audio is disconnected during a call as handover is repeated during the call.

In contrast, as in the exemplary embodiment, if the wireless terminal device (STA) controls the handover based on the average received signal strength: A in the correlation period: tx at each of the “time A”, the “time B” and the “time C” shown in FIG. 10, erroneous recognition that the received signal strength decreased in the interval from the “origin” to the “time A” does not occur, and no handover is performed in the interval from the “origin” to the “time B”, thereby enabling a proper handover after the “time B”.

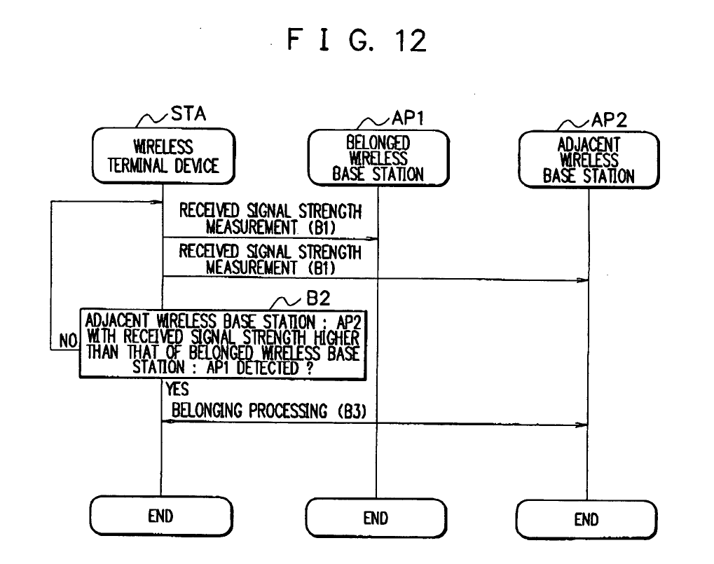

As a method for controlling a handover, a case in which a method as shown in FIG. 12 is applied is assumed.

In the method for controlling a handover shown in FIG. 12, the wireless terminal device (STA) first measures the received signal strength of the wireless terminal device (STA), the belonged (present) wireless base station (AP1) and the neighbor (adjacent) wireless base station (AT2) present in the neighbor of the wireless terminal device (STA) (B1 of FIG. 12).

When the wireless terminal device (STA) determines that it detects the neighbor wireless base station (AP2) with the received signal strength higher than that of the belonged wireless base station (AP1) to which the wireless terminal device (STA) belongs based on the measured received signal strength (B2/Yes at FIG. 12), the wireless terminal device (STA) controls to execute the handover so as to belong to the neighbor wireless base station (AP2) (B3 in FIG. 12).

In the method for controlling a handover shown in FIG. 12, if the wireless terminal device (STA) controls a handover by using the received signal strengths of the belonged wireless base station (AP1) and the neighbor wireless base station (AP2) shown in FIG. 8 as they are, it erroneously recognizes that the neighbor wireless base station with the received signal strength higher than that of the belonged wireless base station to which the wireless terminal device (STA) belongs in the interval from the “origin” to the “time B”. This causes a problem in that audio is disconnected during a call as a handover is repeated during the call.

In contrast, in the exemplary embodiments, if the wireless terminal device (STA) controls the handover based on the average received signal strength: A in the correlation period: tx at each of the “time A”, the “time B” and the “time C” shown in FIG. 10, erroneous recognition that the received signal strength higher than that of the belonged wireless base station to which the wireless terminal device (STA) belongs is detected in the interval from the “origin” to the “time B” does not occur, and no handover is performed in the interval from the “origin” to the “time B”, thereby enabling a proper handover after the “time B”.

As such, the wireless terminal device (STA) performs the interference detecting control and the handover control with higher accuracy than that of the conventional method by performing a series of processes shown in FIG. 5 and FIG. 6, calculating the highly accurate received signal strength in consideration of various noises caused by the environment in which the wireless communication is performed and performing the interference control and the handover control based on the calculated highly accurate received signal strength.

Although the wireless terminal device (STA) calculates the correlation period: tx at each time, calculates the average value: A of the received signal strength measured in the correlation period: tx based on the correlation period: tx at each calculated time, and makes the average value: A of the calculated received signal strength the value of the received signal strength at the time: t as shown in FIG. 6 and FIG. 7 in the abovementioned exemplary embodiment, it can calculate the median value of the received signal strength measured in the correlation period: tx based on the correlation period: tx at each time. It can also make the median value of the calculated received signal strength the value of the received signal strength at the time; t.

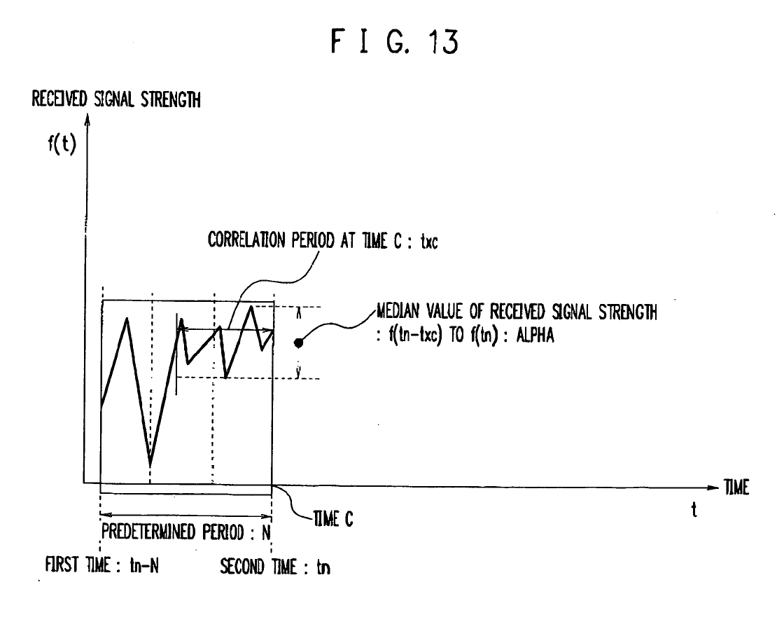

In such a case, when the wireless terminal device (STA) calculates the correlation period: txc at the time C, it calculates the median value; alpha of the received signal strength: f(tn−tx) to t(tn) measured in the correlated period: txc and make the calculated median value: alpha the value of the received signal strength at the time C as shown in FIG. 13.

The wireless terminal device (STA) also calculates the average value of the received signal strength based on the value of the maximum value and the minimum value of the received signal strength measured in the correlation period: tx subtracted from the received signal strength measured in the correlation period: tx based on the correlation period: tx at each time, and makes the average value of the calculated received signal strength the value of the received signal strength at the time: t.

In such a case, it can be calculated using formula (5) below.

$$A = \frac{1}{tx} {\sum }_{t = tn - tx}^{tn} f ( t ) \qquad [ Formula 5 ]$$

Here, tx indicates the correlation period “tx”, tn indicates the second time “tn”, f(t) indicates the received signal strength “f(t)” measured for a predetermined period “N”, and it is assumed that the maximum value and the minimum value are subtracted from the received signal strength “f(t)”.

Although it is assumed that the wireless terminal device (STA) calculates the average value: A of the received signal strength by subtracting the maximum value and the minimum value of the received signal strength “f(t)” in the above formula (5), it calculates the average received signal strength by subtracting a plurality values of the received signal strength whose received signal strength value is large (or small) instead of subtracting only the maximum value and the minimum value of the received signal strength “f(t)” in calculating the average value: A of the received signal strength.

It weighs the received signal strength measured in the correlation period: tx based on the correlation period: tx at each time, calculates the average value of the weighted received signal strength, and the average value of the calculated received signal strength the value of the received signal strength at the time: t.

In such a case, it can be calculated using formula (6) below:

$$A = \frac{{\sum }_{t = tn - tx}^{tn} {w}_{t} f ( t )}{{\sum }_{t = tn - tx}^{tn} {w}_{t}} \qquad [ Formula 6 ]$$

Here, tx indicates the correlation period “tx”, tn indicates the second time “tn”, Wt indicates a weighting factor for each time t, and f(t) indicates a received signal strength “f(t)” measured for a predetermined period “N”.

The weighting factor: Wt of formula (6) can be such that as it is closer the second time: tn, the value of the weighting factor: Wt becomes larger so that the average value: A of the received signal strength with high priority put on the second time: tn, which is the latest time of measuring the received signal strength: f(t) is calculated.

As such, the wireless terminal device (STA) is adapted to perform a series of processes shown in FIG. 5 and FIG. 6 to calculate the correlation period: tx at each time, and handle the value of the received signal strength in any environmental conditions as the value of the received signal strength at the time “t” based on the value of the received signal strength measured in the calculated correlation period tx at each time.

### Second Exemplary Embodiment

Now, the second exemplary embodiment of the present invention will be described below.

In the wireless communication system in the first exemplary embodiment, the wireless terminal device (STA) performs a series of processes shown in FIG. 5 and FIG. 6, calculates the highly accurate received signal strength in consideration of various noises that occurs according to the environment in which the wireless communication is performed, and performs the interference detecting control and the handover control based on the calculated highly accurate received signal strength.

In the wireless communication system in the second exemplary embodiment, the wireless base station (AP) performs a series of processes shown in FIG. 5 and FIG. 6, calculates the highly accurate received signal strength in consideration of various noises occurs according to the environment in which the wireless communication is performed, and selects an empty channel based on the calculated highly accurate received signal strength.

Accordingly, it can select an empty channel by using a highly accurate measured result in consideration of various noises according to the environment in which the wireless communication is performed.

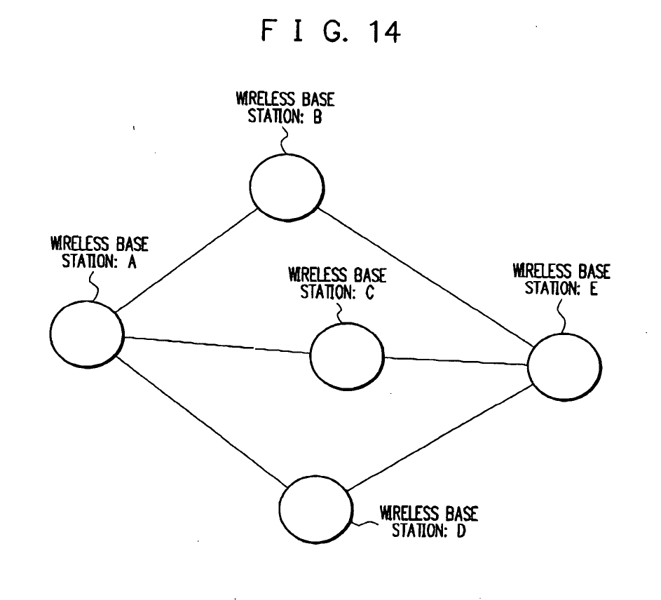

The wireless communication system in the second exemplary embodiment will be described with reference to FIG. 14.

The wireless communication system in the second exemplary embodiment has the similar system configuration as that of the first exemplary embodiment.

For the wireless communication system of the second exemplary embodiment, the case in which the wireless base station (A) measures the received signal strength of the signal received from the neighbor wireless base stations (B, C, D) and selects an empty channel based on the measured received signal strength as shown in FIG. 14, will be described.

First, the wireless base station (A) obtains information on the wireless channel used by the neighbor wireless base stations (B, C, D) by using a well-known scanning method.

At this moment, the wireless base station (A) also obtains the received signal strengths of the neighbor wireless base stations (B, C, D).

As the scanning method, the active scanning, the passive scanning and the like disclosed in Non-Patent Document 1 are applied.

The active scanning is a method for searching a network by exchanging Probe Request/Response frame.

The passive scanning is a method for searching a network by monitoring beacon.

Next, the wireless base station (A) determines whether a wireless channel that is unused by the neighbor wireless base stations (B, C, D) is present based on wireless channel information obtained from the neighbor wireless base stations (B, C, D).

When the wireless base station (A) determines that no wireless channel which is unused by the neighbor wireless base stations (B, C, D) is present, it performs a series of processes shown in FIG. 6 based on the received signal strength obtained from the neighbor base stations (B, C, D) and calculates the highly accurate received signal strength in consideration of various noises occurs according to the environment in which the wireless communication is performed.

Then, the wireless base station (A) selects the wireless base station with the minimum received signal strength among the neighbor wireless base stations (B, C, D) based on the calculated received signal strength and selects the wireless channel used by the selected wireless base station as an empty channel.

For example, it is assumed that the wireless base station (B) uses a wireless channel 1ch and the received signal strength calculated by the process shown in FIG. 5 LS 90.

It is also assumed that the wireless base station (C) uses a wireless channel 6ch and the received signal strength calculated by the process shown in FIG. 5 is 30.

It is yet also assumed that the wireless base station (D) uses a wireless channel 11ch and the received signal strength calculated by the process shown in FIG. 5 is 50.

In such a case, the wireless base station (A) selects the wireless base station (C) with the minimum received signal strength 30, and determines that the wireless channel 6ch used by the wireless base station (C) is an empty channel.

When the wireless base station (A) determines that no wireless channel that is unused by the neighbor wireless base stations (B, C, D) is present, it performs a series of processes shown in FIG. 5 based on the received signal strength obtained from the neighbor wireless base station, (B, C, D), and calculates the highly accurate received signal strength.

Then, it selects the wireless base station with the minimum received signal strength among the neighbor wireless base stations (B, C, D) based on the calculated highly accurate received signal strength, and selects the wireless channel used by the selected wireless base station as the empty channel.

That enables the wireless base station (A) to select an empty channel by using a highly accurate measured result in consideration of the various noises that occurs according to the environment in which wireless communication is performed.

Although a wireless base station with the minimum received signal strength is selected among the neighboring wireless base stations (B, C, D) and the wireless channel used by the selected wireless base station is selected as an empty channel in the abovementioned embodiment, the wireless base station (A) is also constructed to select the wireless base station with the received signal strength below a predetermined threshold among the neighbor base stations (B, C, D) and select the wireless channel that is used by the selected wireless base station as an empty channel.

The wireless terminal device (STA) can also perform the abovementioned selection of an empty channel.

### Third Exemplary Embodiment

Now, the third exemplary embodiment of the present invention will be described.

In the wireless communication system in the third exemplary embodiment, the wireless base station (AP) performs a series of processes shown in FIG. 5 and calculates the highly accurate received signal strength in consideration of various noises that occur according to the environment in which the wireless communication is performed.

The wireless base station (AP) exemplarily performs control on a path of the wireless link between the wireless base station (AP) and the adjacent wireless base station (AP) based on the calculated received signal strength.

Accordingly, the wireless base station (AP) performs control of a path of the wireless link by using the highly accurate measured result in consideration of the various noises under the environment in which wireless communication is performed.

The wireless communication system in the third exemplary embodiment will be described with reference to FIG. 14.

The wireless communication system in the third exemplary embodiment has a similar system configuration as that of the first exemplary embodiment.

The wireless communication system in the third exemplary embodiment is described for the control on a path of the wireless link in the case in which the wireless base station (A) communicates with the wireless base station (E) as shown in FIG. 14.

For example, when the wireless base station (A) communicates with the wireless base station (E), it must pass through any of the wireless base stations (B, C, D).

In such a case, the wireless base station (A) performs a series processes shown in FIG. 5 and calculates the highly accurate received signal strength in consideration of various noises that occurs according to the environment in which the wireless communication is performed.

Then, the wireless base station (A) selects the optimum wireless base station from a plurality of adjacent wireless base stations (B, C, D) and communicates with the wireless base station (E) via the selected wireless base station by controlling a path of a wireless link based on the calculated received signal strength.

As a method for controlling a path of the wireless link, exemplary methods below are considered.

First, when the wireless base station (A) is communicating with the wireless base station (E) via the wireless base station (D), the wireless base station (A) measures the received signal strength of the wireless base station (D).

Then, the wireless base station (A) compares the measured received signal strength and a threshold, which is an exemplary criterion of executing a handover. When it is determined that the received signal strength of the wireless base station (D) drops below the threshold, which is a criterion of executing a handover, the wireless base station (A) searches other neighbor (adjacent) wireless base stations (B, D).

The wireless base station (A) selects the wireless base station (B) with a high received signal strength based on the searched result and controls to communicate with the wireless base station (E) via the selected wireless base station (B).

Accordingly, the wireless base station (A) controls the path of the wireless link to use the wireless link with other wireless base station (B) with a high received signal strength instead of using the wireless link with the wireless base station (D).

When the wireless base station (A) is communicating with the wireless base station (E) via the wireless base station (D), it measures the received signal strengths of a plurality of neighbor wireless base stations (B, C, D).

When the wireless base station (A) detects the optimum wireless base station (B) with a received signal strength higher than that of the wireless base station (D) based on the received signal strengths of the measured plurality of wireless base stations (B, C, D), the wireless base station (A) controls to communicate with the wireless base station (E) via the optimum wireless base station (B).

Accordingly, the wireless base station (A) controls the path of the wireless link to use the wireless link with other wireless base station (B) with a high received signal strength instead of using the wireless link with the wireless base station (D).

In such a manner, the wireless base station (A) performs a series of processes shown in FIG. 5 to calculate a highly accurate received signal strength in consideration of various noises that occur according to the environment in which the wireless communication is performed.

Then, wireless base station (A) controls the path of the wireless link based on the calculated received signal strength.

Accordingly, the wireless base station (A) selects an optimum wireless base station from the plurality of adjacent wireless base stations (B, C, D) and communicates with the wireless base station (E) via the selected wireless base station.

The wireless terminal device (STA) also performs control on the abovementioned path of the wireless link.

The scope of the present invention is not limited to the exemplary embodiments and those skilled in the art can construct embodiments with various modifications by making any correction or substitution to the exemplary embodiments.

Although the communication quality for recognizing the communication state is exemplarily described based on the received signal strength in the exemplary embodiments, the abovementioned received signal strength is only an example, and any information is applied to the exemplary embodiments as the communication quality if only the information is for recognizing the communication state.

As the information for recognizing the communication state, the FER (Frame Error Rate), the PER (Packet Error Rate), the BER (Bit Error Rate), the CRC (Cyclic Redundancy Check) rate, the FCS (Frame Check Sequence) rate, the SNR (Signal to Noise Ratio), the resending number are included. These information items may be arbitrarily combined and applied as measuring parameters for the communication quality.

Although the autocorrelation function: G(k) with f(t+k) that is delayed from an arbitrary time by a predetermined time: t is calculated by using formula (1) based on the measured result: f(t) at step S2 shown in FIG. 5, it can be calculated by using formula (7) below.

By using formula (7), the autocorrelation function: G(k) in consideration of the case in which redundant part between f(t) and f(t+k) decreases can also be calculated.

$$G ( k ) = \frac{1}{N - k} {\sum }_{t = 0}^{N - 1 - k} f ( t ) \times f ( t + k ) \\ k = ( 0 , 1 , 2 , 3 , … N - 1 ) \qquad [ Formula 7 ]$$

Here, N indicates a predetermined period “N” measured at step S1, f(t) indicates the communication quality “f(t)” measured for the predetermined period “N”, and f(t+k) indicates past communication quality “f(t+k)” that is delayed from an arbitrary time: t by the predetermined time: k.

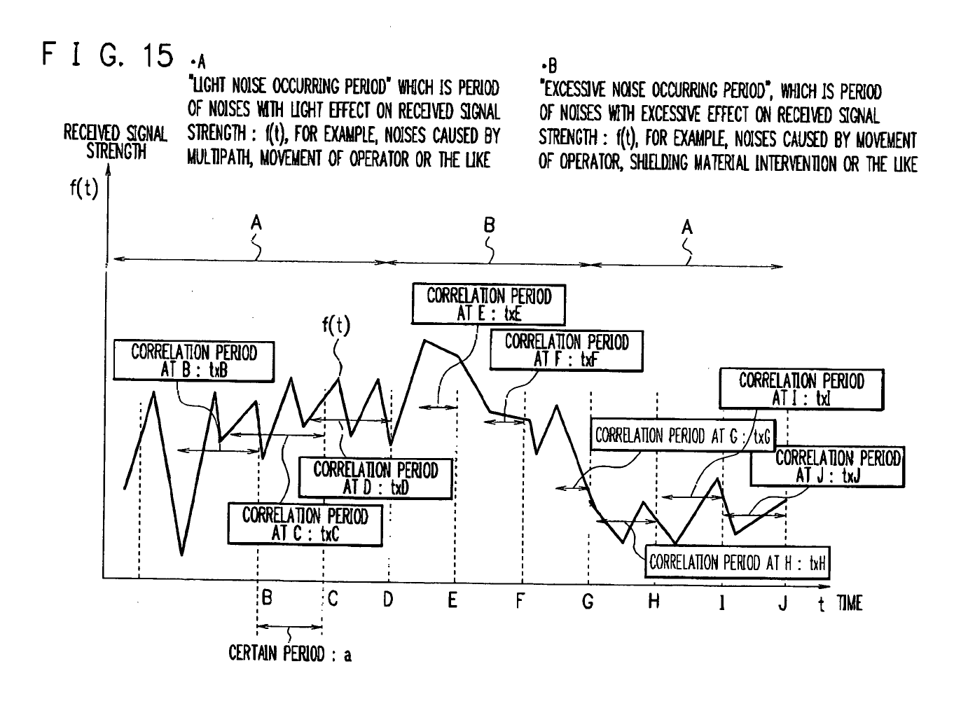

Although the processing shown in FIG. 5 and FIG. 6 is performed at the times B, C, D, . . . and for each predetermined period N, the correlation period: tx for each predetermined period: N is calculated, the measured result of the received signal strength: f(t) is determined at each of the times B, C, D, . . . based on the correlation period: tx calculated by the predetermined period: N, and the highly accurate measured result is obtained in consideration of various noises that occur according to the environment in which the wireless communication is performed, it is also possible to divide the correlation period into a “light noise occurring period”, which is a period of noises with a light effect on the received signal strength: f(t) (correlation period: period with long tx), and an “excessive noise occurring period”, which is a period of noises with an excessive effect on the received signal strength: f(t) (correlation period: a period with short tx), based on the correlation period: tx calculated by the predetermined period: N as shown in FIG. 15 to apply the information divided into the “light noise occurring period” and the “excessive noise occurring period” to the conditions for various determination.

For example, the “light noise occurring period” is determined as a period in which such a noise as multipath, movement of the operator or the like is occurring, and the “excessive noise occurring period” is determined as a period in which such a noise as movement of the operator, a shielding material intervention or the like is occurring. If it is determined that the “excessive noise occurring period” is occurring, then it is possible to control to start the abovementioned interference avoiding control, handover control, path control on a wireless link and the like by determining that such a noise as movement of the operator, a shielding material intervention or the like is occurring.

As the correlation periods (tx_{B}, tx_{C}, tx_{D}) calculated at the times B, C and D are long correlation periods: tx in FIG. 15, it is determined as the “light noise occurring period”.

As the correlation periods (tx_{E}, tx_{F}, tx_{G}) calculated at the times E, F and G are short correlation periods: tx, it is determined as the “excessive noise occurring period”.

As the correlation periods (tx_{H}, tx_{I}, tx_{J}) calculated at the times H, I and J are long correlation periods: tx, it is determined as the “light noise occurring period”.

FIG. 15 shows a state in which the determine results are divided into the “light noise occurring period” and the “excessive noise occurring period”.

Determination on whether the correlation period: tx is long or short is determined by determination on whether the correlation period: tx is long or short by setting a threshold and determining whether the correlation period: tx is more than the threshold or not.

Although the correlation period: tx, during which a correlation is found in the communication quality “f(tn), f(tn−1), f(tn−2), . . . f(tn−tx)”, is calculated at the second time: tn, which is the last time of measuring the received signal strength: f(t), as shown in FIG. 6, the correlation period: tx is not limited to be calculated at the second time: tn, which is the last time of measuring the received signal strength: f(t), and the correlation period: tx, during which a correlation is found in the communication quality “f(tn), f(tn−1), f(tn−2), . . . f(tn−tx)”, may be calculated at a particular time: tn, at which the received signal strength: f(t) is measured.

Although the wireless communication system that outstandingly generates various noises according to the environment in which the wireless communication is performed is mainly described in exemplary embodiments, the technical concept of the exemplary embodiments may be applied to any communication device in the abovementioned embodiments whether it is wired or wireless.

The controlling operations in the wireless devices such as the wireless base station (AP), the wireless terminal device (STA) and the like that form the wireless communication system may be performed by hardware, software or a combination of both of them.

If the processing is performed by software, then it is possible to install a program recording the processing sequence in a memory in a computer integrated in dedicated hardware for execution or install the program in a general purpose computer that executes various types of processing.

For example, the program may be previously recorded in a computer-readable medium such as a hard disk or a ROM (Read Only Memory).

Alternatively, the program may be temporally or permanently stored (recorded) in a removable recording medium such as a floppy disk, a CD-ROM (Read Only Memory), a MO (Magneto optical) disk, a DVD (Digital Versatile Disc), a magnetic disk, a semiconductor memory and the like.

Such a removable recording medium may be provided as package software.

The program may be installed from the abovementioned removable recording medium to a computer or wirelessly transferred from a download site to a computer through wires from the download site to a computer via such a network as a LAN (Local Area Network) and the Internet so that the computer receives the transferred program and install the program into a recording medium such as an embedded hard disk.

The processes explained in the exemplary embodiments may be performed serially, in parallel, or individually according to the throughput of the device or other factors.

The radio communication system may have a logical aggregation of a plurality of devices or a configuration of functions of respective devices.

The embodiments have the features below according to the description of the abovementioned embodiments.

The communication quality device may include:

a communication quality measuring unit that measures communication quality “f(t)” for recognizing the communication state for a predetermined period “N”;

a correlation period calculating unit that calculates a correlation period “tx” during which a correlation is found in the communication quality “f(tn), f(tn−1), f(tn−2), . . . f(tn−tx)” at a particular time of the predetermined period during which the communication quality measuring unit performs measuring “for example, the second time: tn”; and

a communication quality result determining unit that determines communication quality result at the particular time “tn” based on correlation communication quality “f(tn−tx) to f(tn)” that is measured in the correlation period “tx” by the communication quality measuring unit.

In the communication quality device,

the communication quality measuring unit, the correlation period calculating unit, and the communication quality result determining unit may perform processing at a certain period “a”.

In the communication quality device,

the communication quality result determining unit calculates the average value “A” of the correlation communication quality “f(tn−tx) to f(tn)” and determines the communication quality result “A” at the particular time “tn”.

In the communication quality device,

the communication quality result determining unit calculates a median value “alpha” of the correlation communication quality “f(tn−tx) to f(tn)” and determines the communication quality result “alpha” at the particular time “tn”.

In the communication quality device,

the communication quality result determining unit calculates the average value “A” of values remaining after subtracting the maximum value and the minimum value from the correlated communication quality “f(tn−tx) to f(tn)” and determines the communication quality result “A” at the particular time “tn”.

In the communication quality measuring device,

the communication quality result determining unit calculates the average value “A” of the correlation communication quality “f(tn−tx) to f(tn)”, which is the weighted correlation communication quality “f(tn−tx) to f(n)” and determines the communication quality result “A” at the particular time “tn”.

In the communication quality measuring device,

the communication quality measuring unit measures the communication quality “f(t)” for recognizing a communication state for a predetermined period “N” from a first time “tn−N” to a second time “tn”,

the correlation period calculating unit calculates the correlation period “tx” during which a correlation is found in the communication quality “f(tn), f(tn−1), f(tn−2), . . . f(tn−tx)” at the second time “tn” measured by the communication quality measuring unit, and

the communication quality result determining unit determines the communication quality result at the second time “tn” based on the correlation communication quality “f(tn−t) to f(tn)” measured in the correlation period “tx” by the communication quality measuring unit.

In the communication quality measuring device,

the correlation period calculating unit includes an autocorrelation calculating unit that calculates an autocorrelation function “G(k)” of the communication quality “f(t)” measured by the communication quality measuring unit for a predetermined period “N” and past communication quality “f(t+k)” that is the communication quality “f(t)” shifted from an arbitrary time “t” by a predetermined time “k”,

a normalized autocorrelation function calculating unit that calculates a normalized autocorrelation function “G1(k)” in which an autocorrelation function “G(k)” calculated by the autocorrelation calculating unit is normalized, and

a calculating unit that calculates the correlation period “tx”, during which the value of the normalized autocorrelation function “G1(k)” becomes a predetermined threshold “gth”, based on the normalized autocorrelation function “G1(k)” that is calculated by the normalized autocorrelation calculating unit.

The communication quality measuring device,

the communication quality result determining unit calculates the average value: A of the correlation communication quality “f(tn−tx) to f(tn)” by formula (8) below:

$$A = \frac{1}{tx} {\sum }_{t = tn - tx}^{tn} f ( t ) \qquad [ Formula 8 ]$$

where tx indicates the correlation period “tx”, tn indicates the second time “tn”, and f(t) indicates the communication quality “f(t)” measured for a predetermined period “N”.

In the communication quality measuring device,

the communication quality result determining unit calculates the average value A of values remaining after subtracting the maximum value and the minimum value from the correlated communication quality “f(tn−tx) to f(tn)” using formula (9) below:

$$A = \frac{1}{tx} {\sum }_{t = tn - tx}^{tn} f ( t ) \qquad [ Formula 9 ]$$

where tx indicates the correlation period “tx”, tn indicates the second time “tn”, and f(t) indicates the communication quality “f(t)” measured for a predetermined period “N”, and the maximum value and the minimum value are subtracted from the communication quality “f(t)” measured for the predetermined period “N”.

In the communication quality measuring device,

the communication quality result determining unit calculates the average value: A of the correlation communication quality “f(tn−tx) to f(tn)” that is the weighted correlation communication quality “f(tn−tx) to f(n)” using formula (10) below:

$$A = \frac{{\sum }_{t = tn - tx}^{tn} {w}_{t} f ( t )}{{\sum }_{t = tn - tx}^{tn} {w}_{t}} \qquad [ Formula 10 ]$$

where tx indicates the correlation period “tx”, tn indicates the second time “tn”, Wt indicates a weighting factor for each time t, and f(t) indicates communication quality “f(t)” measured for a predetermined period “N”.

In the communication quality measuring device,

the autocorrelation function: G(k) calculated by the autocorrelation calculating unit is calculated using formula (11) below:

$$G ( k ) = \frac{1}{N} {\sum }_{t = 0}^{N - 1} f ( t ) \times f ( t + k ) \\ k = ( 0 , 1 , 2 , 3 , … N - 1 ) \qquad [ Formula 11 ]$$

where, N indicates a predetermined period “N” measured by the communication quality measuring unit, f(t) indicates the communication quality “f(t)” measured for a predetermined period “N”, and f(t+k) indicates the past communication quality “f(t+k)”.

In the communication quality measuring device,

the normalized autocorrelation function: G1(k) calculated by the normalized autocorrelation calculating unit is calculated using formula (12) below:
G₁(k)=G(k)/G(0) [Formula 12]

where, G(k) indicates the autocorrelation quality function “G(k)” calculated by the autocorrelation calculating unit, and G(0) indicates the function “G(0)” which is the autocorrelation function: G(k) calculated by the autocorrelation calculating unit substituted by 0.

The communication quality measuring device includes an interference detecting unit that determines whether electric wave interference is occurring based on the communication quality result.

In the communication quality measuring device,

the communication quality measuring unit measures the communication quality of a plurality of communication devices,

the communication quality result determining unit determines the communication quality result for each communication device, and

the interference detecting unit determines whether electric wave interference is occurring between communication devices based on the communication quality result determined by the communication quality result determining unit for each communication device.

The communication quality measuring device includes

a handover controlling unit that controls a handover based on the communication quality result.

In the communication quality measuring device,

the communication quality measuring device measures the communication quality of the wireless base station to which the communication quality measuring device belongs,

the communication quality result determining unit determines the communication quality result of the wireless base station, and

the handover controlling unit compares the communication quality result of the wireless base station and a threshold that is a criterion of executing a handover, and if the communication quality result of the wireless base station is below the threshold, controls to execute the handover so as to belong to another wireless base station.

In the communication quality measuring device,

the communication quality measuring unit measures the communication quality of a plurality of wireless base stations,

the communication quality result determining unit determines the communication quality result for each wireless base station, and

the handover control unit controls to execute a handover to belong to a wireless base station with a high communication quality result, if a wireless base station with the communication quality result higher than that of the wireless base station to which the communication quality measuring device belongs is detected based on the communication quality result determined by the communication quality result determining unit for each wireless base station.

The communication quality measuring device includes

a channel searching unit that searches a wireless channel to be used in the wireless communication, wherein

the channel searching unit selects the wireless channel to be used in the wireless communication from the wireless channels used by the communication device based on the communication quality result, if no wireless channel which is unused by the communication devices near the communication quality measuring device is present.

In the communication quality measuring device,

the communication quality measuring unit measures the communication quality of the communication device,

the communication quality result determining unit determines the communication quality result for each communication device, and

the channel searching unit selects the wireless channel being used by the wireless device corresponding to the minimum communication quality result as the wireless channel to be used by the wireless communication based on the communication quality result determined by the communication quality result determining unit for each communication device if no wireless channel which is unused by the communication device is present.

In the communication quality measuring device,

the communication quality measuring unit measures the communication quality of the communication device,

the communication quality result determining unit determines the communication quality result for each communication device, and

the channel searching unit selects the wireless channel being used by the wireless device corresponding to the communication quality result below a predetermined threshold as the wireless channel to be used by the wireless communication based on the communication quality result determined by the communication quality result determining unit for each communication device if no wireless channel which is unused by the communication device is present.

The communication quality measuring device includes

a link controlling unit that performs path control of the wireless link with the communication device adjacent to the communication quality measuring device based on the communication quality result.

In the communication quality measuring device,

the communication quality measuring unit measures the communication quality of the communication device adjacent to the communication quality measuring device,

the communication quality result determining unit determines the communication quality result for the communication device, and

the link controlling unit compares the communication quality result of the communication device and a threshold that is a criterion of executing the path control on the wireless link, and if the communication quality result of the wireless base station is below the threshold, performs the path control of the wireless link to use the wireless link with another communication device without using the wireless link with the communication device.

In the communication quality measuring device,

the communication quality measuring unit measures the communication quality of a plurality of communication devices adjacent to the communication quality measuring device,

the communication quality result determining unit determines the communication quality result for each communication device, and

the link controlling unit performs the path control of the wireless link to use the wireless link with another communication device with a high communication quality result if the communication device with the communication quality result higher than that of the communication device used by the communication quality measuring device is detected based on the communication quality result determined by the communication quality result determining unit for each communication device.

A communication quality measuring method is for the communication quality device for measuring communication quality to recognize a communication state, wherein the method includes:

a communication quality measuring step of measuring communication quality “f(t)” for recognizing the communication state for a predetermined period “N”;

a correlation period calculating step of calculating a correlation period “tx” during which a correlation is found in the communication quality “f(tn), f(tn−1), f(tn−2), . . . f(tn−tx)” at a particular time that is measured at the communication quality measuring step, “for example, at the second time: tn”; and

a communication quality result determining step of determining a communication quality result at the particular time “tn” based on correlation communication quality “f(tn−tx) to f(tn)” that is measured in the correlation period “tx” at the communication quality measuring step.

In the communication quality measuring method,

the communication quality measuring step, the correlation period calculating step, and the communication quality result determining step are performed for every certain period.

A communication quality measuring program in a computer-readable medium is for the communication quality measuring device for measuring communication quality to recognize a communication state, wherein the program causes computer to execute

a communication quality measuring process of measuring communication quality “f(t)” for recognizing the communication state for a predetermined period “N”;

a correlation period calculating process of calculating a correlation period “tx” during which a correlation is found in the communication quality “f(tn), f(tn−1), f(tn−2), . . . f(tn−tx)” at a particular time that is measured at the communication quality measuring step, “for example, at the second time: tn”; and

a communication quality result determining process of determining a communication quality result at the particular time “tn” based on correlation communication quality “f(tn−tx) to f(tn)” that is measured in the correlation period “tx” in the communication quality measuring process.

The communication quality measuring process, the correlation period calculating process, and the communication quality result determining process may be performed at a certain period.

The abovementioned communication quality measuring device, the communication quality measuring method and the communication measuring program can be applied to a purpose for measuring the radio quality of the wireless network system, specifically to a network system involving movement such as audio communication by the VoIP using the wireless LAN.

The communication quality measuring device, the communication quality measuring method and the communication measuring program can also be applied to an aspect of the wireless ad hoc network through which the wireless terminal devices directly communicates with each other.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication quality measuring device, comprising:
a communication quality measuring unit that measures communication quality for recognizing a communication state for a predetermined period;
a correlation period calculating unit that calculates a correlation period during which a correlation is found in the communication quality at a particular time of the predetermined period during which said communication quality measuring unit performs measuring; and
a communication quality result determining unit that determines a communication quality result at said particular time based on correlation communication quality that is measured during said correlation period by said communication quality measuring unit.

2. The communication quality measuring device according to claim 1, wherein
said communication quality measuring unit, said correlation period calculating unit, and said communication quality result determining unit perform processing for every certain period.

3. The communication quality measuring device according to claim 1, wherein
said communication quality result determining unit calculates an average value of said correlation communication quality and determines the communication quality result at said particular time.

4. The communication quality measuring device according to claim 1, wherein
said communication quality result determining unit calculates a median value of said correlation communication quality and determines the communication quality result at said particular time.

5. The communication quality measuring device according to claim 1, wherein
said communication quality result determining unit calculates an average value of values remaining after subtracting a maximum value and a minimum value from said correlation communication quality and determines the communication quality result at said particular time.

6. The communication quality measuring device according to claim 1, wherein
said communication quality result determining unit calculates an average value of said correlation communication quality that comprises said correlation communication quality weighted and determines the communication quality result at said particular time.

7. The communication quality measuring device according to claim 1, wherein
said communication quality measuring unit measures the communication quality for recognizing the communication state for a predetermined period from a first time to a second time,
said correlation period calculating unit calculates the correlation period during which a correlation is found in the communication quality at said second time during which said communication quality measuring unit performs measuring, and
said communication quality result determining unit determines the communication quality result at said second time based on the correlation communication quality measured in said correlation period by said communication quality measuring unit.

8. The communication quality measuring device according to claim 7, wherein
said correlation period calculating unit comprises:
an autocorrelation calculating unit that calculates an autocorrelation function of the communication quality measured by said communication quality measuring unit for a predetermined period and a past communication quality which comprises said communication quality shifted from an arbitrary time by a predetermined time;
a normalized autocorrelation function calculating unit that calculates a normalized autocorrelation function in which an autocorrelation function calculated by said autocorrelation calculating unit is normalized; and
a calculating unit that calculates the correlation period, during which a value of said normalized autocorrelation function becomes a predetermined threshold, based on the normalized autocorrelation function that is calculated by said normalized autocorrelation calculating unit.

9. The communication quality measuring device according to claim 8, wherein
said communication quality result determining unit calculates an average value: A of said correlation communication quality using formula (1) below:
$$A = \frac{1}{tx} {\sum }_{t = tn - tx}^{tn} f ( t ) \qquad [ Formula 1 ]$$
where tx indicates the correlation period, tn indicates the second time, and f(t) indicates the communication quality measured for a predetermined period “N”.

10. The communication quality measuring device according to claim 8, wherein
said communication quality result determining unit calculates an average value: A of values remaining after subtracting a maximum value and a minimum value from said correlated communication quality using formula (2) below:
$$A = \frac{1}{tx} {\sum }_{t = tn - tx}^{tn} f ( t ) \qquad [ Formula 2 ]$$
where tx indicates the correlation period, tn indicates the second time, and f(t) indicates the communication quality measured for a predetermined period, and the maximum value and the minimum value are subtracted from the communication quality measured for the predetermined period.

11. The communication quality measuring device according to claim 8, wherein
said communication quality result determining unit calculates an average value: A of said correlation communication quality that is said correlation communication quality weighted using formula (3) below:
$$A = \frac{{\sum }_{t = tn - tx}^{tn} {w}_{t} f ( t )}{{\sum }_{t = tn - tx}^{tn} {w}_{t}} \qquad [ Formula 3 ]$$
where tx indicates the correlation period, tn indicates the second time, Wt indicates a weighting factor for each time t, and f(t) indicates communication quality measured for a predetermined period.

12. The communication quality measuring device according to claim 8, wherein
the autocorrelation function: G(k) calculated by said autocorrelation calculating unit is calculated using formula (4) below:
$$G ( k ) = \frac{1}{N} {\sum }_{t = 0}^{N - 1} f ( t ) ⨯ f ( t + k ) \\ k = ( 0 , 1 , 2 , 3 , … N - 1 ) \qquad [ Formula 4 ]$$
where, N indicates a predetermined period measured by the communication quality measuring unit, f(t) indicates the communication quality measured for a predetermined period, and f(t+k) indicates a past communication quality.

13. The communication quality measuring device according to claim 12, wherein
the normalized autocorrelation function: G1(k) calculated by said normalized autocorrelation calculating unit is calculated using formula (5) below:
G1(k)=G(k)/G(0) [Formula 5]
where, G(k) indicates the autocorrelation quality function calculated by the autocorrelation calculating unit, and G(0) indicates the function which is the autocorrelation function: G(k) calculated by the autocorrelation calculating unit substituted by 0.

14. The communication quality measuring device according to claim 1, comprising:
an interference detecting unit that determines whether an electric wave interference is occurring based on said communication quality result.

15. The communication quality measuring device according to claim 14, wherein
said communication quality measuring unit measures the communication quality of a plurality of communication devices,
said communication quality result determining unit determines said communication quality result for each communication device, and
said interference detecting unit determines whether electric wave interference is occurring between communication devices, based on said communication quality result determined by said communication quality result determining unit for each communication device.

16. The communication quality measuring device according to claim 1, comprising:
a handover controlling unit that controls a handover based on said communication quality result.

17. The communication quality measuring device according to claim 16, wherein
said communication quality measuring device measures the communication quality of the wireless base station to which said communication quality measuring device belongs,
said communication quality result determining unit determines said communication quality result of said wireless base station, and
said handover controlling unit compares said communication quality result of said wireless base station and a threshold that comprises a criterion of executing a handover, and if said communication quality result of said wireless base station is below said threshold, controls to execute the handover so as to belong to another wireless base station.

18. The communication quality measuring device according to claim 16, wherein
said communication quality measuring unit measures the communication quality of a plurality of wireless base stations,
said communication quality result determining unit determines said communication quality result for each wireless base station, and
said handover control unit controls to execute a handover to belong to a wireless base station with a high communication quality result, if a wireless base station with said communication quality result higher than that of the wireless base station to which said communication quality measuring device belongs is detected, based on said communication quality result determined by said communication quality result determining unit for each wireless base station.

19. The communication quality measuring device according to claim 1, comprising:
a channel searching unit that searches a wireless channel to be used in a wireless communication, wherein
said channel searching unit selects the wireless channel to be used in the wireless communication from the wireless channels used by said communication device based on said communication quality result, if no wireless channel which is unused by the communication devices near said communication quality measuring device is present.

20. The communication quality measuring device according to claim 19, wherein
said communication quality measuring unit measures the communication quality of said communication device,
said communication quality result determining unit determines said communication quality result for each communication device, and
said channel searching unit selects the wireless channel being used by the wireless device corresponding to said minimum communication quality result as the wireless channel to be used by the wireless communication based on said communication quality result determined by said communication quality result determining unit for each communication device if no wireless channel which is unused by said communication device is present.

21. The communication quality measuring device according to claim 19, wherein
said communication quality measuring unit measures the communication quality of said communication device,
said communication quality result determining unit determines said communication quality result for each communication device, and
said channel searching unit selects the wireless channel being used by the wireless device corresponding to said communication quality result below a predetermined threshold as the wireless channel to be used by the wireless communication based on said communication quality result determined by said communication quality result determining unit for each communication device if no wireless channel which is unused by the communication device is present.

22. The communication quality measuring device according to claim 1, comprising:
a link controlling unit that performs a path control of the wireless link with the communication device adjacent to said communication quality measuring device based on said communication quality result.

23. The communication quality measuring device according to claim 22, wherein
said communication quality measuring unit measures the communication quality of the communication device adjacent to said communication quality measuring device,
said communication quality result determining unit determines said communication quality result for said communication device, and
said link controlling unit compares said communication quality result of said communication device and a threshold, which comprises a criterion of executing the path control on the wireless link, and if said communication quality result of said wireless base station is below said threshold, performs the path control of the wireless link to use the wireless link with another communication device without using the wireless link with said communication device.

24. The communication quality measuring device according to claim 22, wherein
said communication quality measuring unit measures the communication quality of a plurality of communication devices adjacent to said communication quality measuring device,
said communication quality result determining unit determines said communication quality result for each communication device, and
said link controlling unit performs the path control of the wireless link to use the wireless link with another communication device with a high communication quality result if the communication device with the communication quality result higher than that of the communication device used by said communication quality measuring device is detected based on said communication quality result determined by said communication quality result determining unit for each communication device.

25. A communication quality measuring device, comprising:
communication quality measuring means for measuring a communication quality for recognizing a communication state for a predetermined period;
correlation period calculating means for calculating a correlation period during which a correlation is found in the communication quality at a particular time of the predetermined period during which said communication quality measuring means performs measuring; and
communication quality result determining means for determining a communication quality result at said particular time based on a correlation communication quality that is measured in said correlation period by said communication quality measuring means.

26. A communication quality measuring method performed in a communication quality device for measuring communication quality for recognizing a communication state, wherein the communication quality device performs:
a communication quality measuring step of measuring communication quality for recognizing a communication state for a predetermined period;
a correlation period calculating step of calculating a correlation period during which a correlation is found in the communication quality at a particular time of the predetermined period during which measurement is performed at said communication quality measuring step; and
a communication quality result determining step of determining a communication quality result at said particular time based on correlation communication quality that is measured in said correlation period at said communication quality measuring step.

27. The communication quality measuring method according to claim 26, wherein
said communication quality measuring step, said correlation period calculating step, and said communication quality result determining step are performed for every certain period.

28. A communication quality measuring program tangibly embodied in a computer-readable medium performed in a communication quality measuring device for measuring communication quality for recognizing a communication state, the program causing a computer to perform:
a communication quality measuring process of measuring communication quality for recognizing a communication state for a predetermined period;
a correlation period calculating process of calculating a correlation period during which a correlation is found in the communication quality at a particular time of the predetermined period during which measurement is performed at said communication quality measuring step; and
a communication quality result determining process of determining a communication quality result at said particular time based on correlation communication quality that is measured in said correlation period in said communication quality measuring process.

29. The communication quality measuring program according to claim 28, wherein
said communication quality measuring process, said correlation period calculating process, and said communication quality result determining process are performed for every certain period.
